(19) United States
(12) Patent Application Publication
(10) Pub. No.: US 2015/0252241 A1
(43) Pub. Date: Sep. 10, 2015

(54) COATED PARTICLE, COMPOSITION INCLUDING SAME, AND HEAT TRANSFER SHEET

(71) Applicant: LMS CO.,LTD, Pyeongtaek-si Gyeonggi-do (KR)

(72) Inventors: Sung Won Jang, Seoul (KR); Oh Kwan Kwon, Gyeonggi-do (KR); Jeong Og Choi, Seoul (KR)

(21) Appl. No.: 14/434,767

(22) PCT Filed: Oct. 1, 2013
(86) PCT No.: PCT/KR2013/008787

§ 371 Date: Apr. 10, 2015

(30) Foreign Application Priority Data
Oct. 17, 2012 (KR) 10-2012-0115227

(51) Int. Cl. C09K 5/14; C08K 9/10

(52) U.S. Cl. CPC C09K 5/14; C08K 9/10

(57) ABSTRACT

The coated particle according to the present invention includes a base particle and a graphene layer which covers the surface of the base particle. Accordingly, a coated particle of which the shape and the particle distribution are easily controlled may be prepared.

### CROSS-REFERENCE TO RELATED APPLICATIONS

This application is the United States national phase of International Application No. PCT/KR2013/008787 filed Oct. 1, 2013, and claims priority to Korean Patent Application No. 10-2012-0115227 filed Oct. 17, 2012, the disclosure of which are hereby incorporated in their entirety by reference.

### TECHNICAL FIELD

The present invention relates to a coated particle, a composition including the same, and a heat transfer sheet, and more particularly, to a coated particle having improved heat transfer characteristics, a composition including the same, and a heat transfer sheet.

### BACKGROUND ART

In general, an electronic product includes various kinds of electronic devices from which heat is generated while the product is driven. Since the electronic product has a problem such as malfunction due to heat generated from the electronic devices, heat radiation sheets have been introduced into the electronic product in order to emit heat generated from the electronic devices.

In the related art, heat generated from the electronic devices was emitted by using a metal heat radiation sheet composed of a metal having high heat conductivity, such as aluminum (Al) or copper (Cu), but there was a problem in that heat transfer characteristics deteriorate as the thickness of the metal heat radiation sheet became small. Further, there is also a disadvantage in that production costs are increased by a high temperature process of manufacturing a metal heat radiation sheet, thereby leading to an increase in unit cost of the heat radiation sheet.

Meanwhile, heat radiation sheets using graphene having excellent heat transfer characteristics, which replaces metal, have been developed. Since graphene has a plate-like structure, a heat radiation sheet using graphene has low heat transfer characteristics in a direction perpendicular to an in-plane direction of graphene compared to heat transfer characteristics of graphene in the in-plane direction thereof. Accordingly, there is a limitation in manufacturing a heat radiation sheet having excellent heat transfer characteristics both in the in-plane direction and in the direction perpendicular to the in-plane direction even though graphene is used.

### DISCLOSURE

### Technical Problem

The present invention provides a coated particle having improved heat transfer characteristics.

The present invention provides a composition including the coated particle.

The present invention provides a heat transfer sheet including the coated particle.

### Technical Solution

The coated particle according to the present invention includes a base particle and a graphene layer. The base particle is composed of a metal, and the graphene layer covers at least a part of the surface of the base particle.

In an exemplary embodiment, the base particle may have a spherical shape, a plate shape, or a wire shape.

In an exemplary embodiment, the graphene layer may include graphene including at least one layer or more.

In an exemplary embodiment, the base particle may be formed of nickel (Ni), copper (Cu), iron (Fe), ruthenium (Ru), cobalt (Co), platinum (Pt), or iridium (Ir). These may be used either independently or in combination of two or more thereof.

The composition according to the present invention includes a base resin and a coated particle. The coated particle is distributed in the base resin, and includes the base particle and the graphene layer. The graphene layer covers at least a part of the surface of the base particle.

In an exemplary embodiment, the content of the coated particle may be 5 parts by weight to 500 parts by weight with respect to 100 parts by weight of the base resin.

In an exemplary embodiment, the composition may further include a carbon-containing powder distributed in the base resin together with the coated particle. In this case, the carbon-containing powder may include carbon nanotubes, graphene flake, oxidized graphene flake, graphite flake, oxidized graphite flake, expanded graphite flake, fullerene, carbon fiber, or carbon black.

In an exemplary embodiment, the content of the carbon-containing powder may be 30 parts by weight or less with respect to 100 parts by weight of the base resin.

In an exemplary embodiment, the base resin may include an ethylene resin, a propylene resin, a vinyl chloride resin, a styrene resin, a carbonate resin, an ester resin, a nylon resin, a silicone resin or an imide resin.

A sheet according to the present invention is a sheet which transfers heat and includes a base film including a base resin, and a coated particle. The coated particle is distributed in the base film, and includes a base particle and a graphene layer which covers at least a part of the surface of the base particle.

### Advantageous Effects

According to the present invention, since a base particle is prepared by using a metal of which the shape is easily controlled and a graphene layer is formed on the surface of the base particle, the shape of the coated particle is easily controlled and it is possible to uniformly distribute the coated particle in a process of manufacturing a sheet.

Further, when a heat transfer sheet is manufactured by using the coated particle according to the present invention, it is possible to manufacture a heat transfer sheet having improved heat transfer characteristics. Heat transfer characteristics may be improved in an in-plane direction of the sheet as well as in a direction perpendicular to the in-plane direction. Accordingly, since a separate sheet for strengthening heat transfer characteristics need not be used, the weight of a device may be reduced.

As described above, the sheet having improved heat transfer characteristics may be used in various electronic devices and electronic equipment, thereby improving heat emission characteristics of the electronic device and the electronic equipment, and improving reliability of the device and the equipment and extending a service life thereof therefrom. In addition, due to weight reduction of a sheet, it is also possible to reduce the weight of the device and the equipment to which the sheet is applied.

### DESCRIPTION OF DRAWINGS

FIG. 1 is a view illustrating base particles according to exemplary embodiments of the present invention.

FIG. 2 is a view illustrating coated particles according to exemplary embodiments of the present invention.

FIG. 3 is a view illustrating a sheet according to an Example of the present invention.

FIG. 4 is a view illustrating a sheet according to another Example of the present invention.

FIG. 5 is a view illustrating a sheet according to a modified Example of the present invention.

FIG. 6 is a view for describing a method for manufacturing a coated particle according to exemplary embodiments of the present invention.

FIG. 7 is a scanning electron microscope photograph of a coated particle according to an Example of the present invention.

FIG. 8 is a graph of the result of measuring a coated particle manufactured according to an Example of the present invention by using Raman spectroscopy.

FIG. 9 is a view for describing a method for manufacturing a sheet according to the Examples of the present invention.

### BEST MODE

Hereinafter, the Examples of the present invention will be described in detail with reference to the accompanying drawings. However, the present invention is not limited to the Examples to be disclosed below, but may be implemented in various other forms, and the present Examples are provided for rendering the disclosure of the present invention complete and for fully representing the scope of the present invention to those skilled in the art.

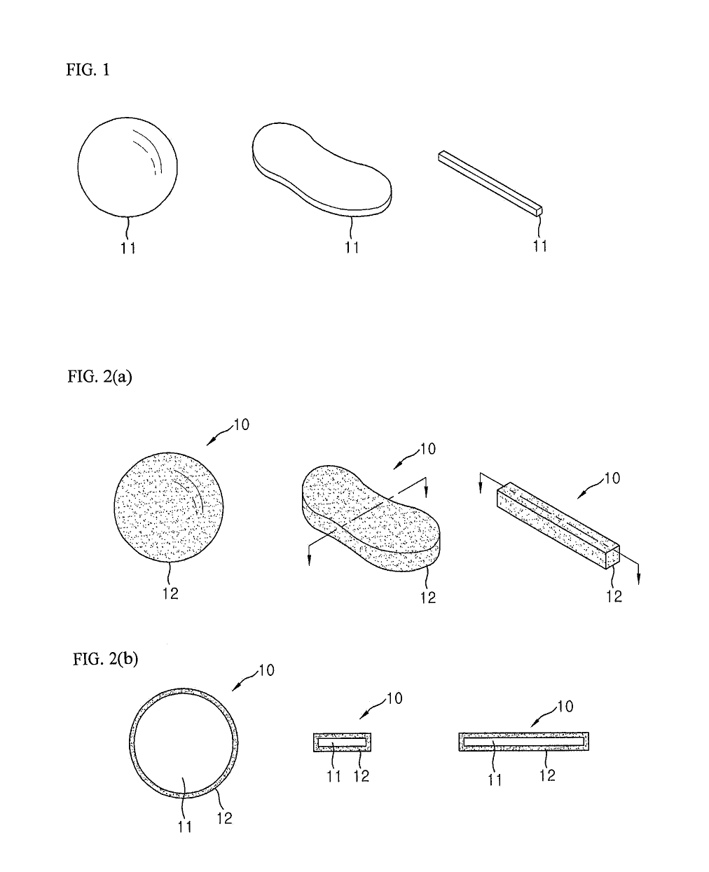

FIG. 1 is a view illustrating base particles according to exemplary embodiments of the present invention, and FIG. 2 is a view illustrating coated particles according to exemplary embodiments of the present invention. In FIG. 2, (a) is a three-dimensional view of the coated particle, and (b) is a cross-sectional view of the coated particle.

Referring to FIGS. 1 and 2, a coated particle 10 includes a base particle 11 and a graphene layer 12.

The base particle 11 is a particle formed of a metal, and serves as a substrate for forming the graphene layer 12. The metal of the base particle 11 may serve as a catalyst in a process of forming the graphene layer 12. The base particle 11 may have various shapes such as a spherical shape, a plate shape, or a wire shape. That is, the base particle 11 is made of a metal, and thus may be easily controlled so as to have various shapes and sizes according to the user's demand characteristics.

For example, the base particle 11 may be spherical. The surface of the base particle 11 may be curved. That is, even though the distance from the center of gravity of the base particle 11 to the surface thereof is not constant, a three-dimensional shape which may be classified as “substantially spherical” may also be typically defined as being spherical.

For example, when the base particle 11 is a spherical particle, the base particle 11 may have a diameter of 5 nm to 10 μm. When the base particle 11 has a diameter of less than 5 nm, it may be difficult to form the graphene layer 12 on the surface of the base particle 11. Furthermore, when the diameter of the base particle 11 exceeds 10 μm, it may be difficult for the coated particle 12 including the base particle 11 to be uniformly dispersed in the base resin during the process of manufacturing the sheet. In this case, the diameter of the base particle 11 is a straight-line distance between two points on the surface of the base particle 11, and is the length of a virtual straight line which connects the two points while passing through the center of gravity of the base particle 11. In this case, when the surface of the base particle 11 is curved, and accordingly, the straight-line distance varies according to the position of the two points, the diameter of the base particle 11 means a maximum value of the straight-line distances. FIGS. 1 and 2 illustrate the case where the base particle 11 is substantially spherical, but the base particle 11 may also have a three-dimensional shape in which the distances from the center of gravity to the surface are different from each other, for example, an egg shape.

For another example, when the base particle 11 is a plate-like particle, the base particle 11 may have a size of 5 nm to 10 μm. When the base particle 11 has a size of less than 5 nm, it may be difficult to form the graphene layer 12 on the surface of the base particle 11. Further, when the size of the base particle 11 exceeds 10 μm, it may be difficult for the coated particle 12 including the base particle 11 to be uniformly dispersed in the base resin during the process of manufacturing the sheet. In this case, the size of the base particle 11 is a straight-line distance between two points on the border of the base particle 11, and when the border of the base particle 11 is curved, and accordingly, the straight-line distance varies according to the position of the two points, the size of the base particle 11 means a maximum value of the straight-line distances. FIGS. 1 and 2 illustrate the case where the base particle 11 has a curved plate-like shape, but the planar shape thereof may be rectangular.

For another example, when the base particle 11 is a wire-like particle, the base particle 11 may have a length of 50 nm to 10 μm. When the base particle 11 has a length of less than 5 nm, it may be difficult to form the graphene layer 12 on the surface of the base particle 11. In addition, when the length of the base particle 11 exceeds 10 μm, it may be difficult for the coated particle 12 including the base particle 11 to be uniformly dispersed in the base resin during the process of manufacturing the sheet. In this case, the length of the base particle 11 means a straight-line distance between both ends in a long-axis direction thereof.

Examples of the metal which forms the base particle 11 include nickel (Ni), copper (Cu), iron (Fe), ruthenium (Ru), cobalt (Co), platinum (Pt) or iridium (Ir), and the like. These may be used either alone or in combination of two or more thereof. That is, the base particle 11 may be formed of only one metal, or of an alloy including two or more thereof.

The graphene layer 12 is a layer formed on the surface of the base particle 11. The graphene layer 12 may wholly cover the surface of the base particle 11, or partially cover only a part thereof. The graphene layer 12 may be a single layer composed of one-layered graphene, or a plurality of layers in which two layers or more of graphene are laminated. Graphene means a material having a two-dimensional planar structure in which six carbon atoms are connected in a honeycomb-like hexagonal form, and the theoretical heat conductivity thereof is about 5,300 W/mK.

The graphene layer 12 covers at least a part of the surface of the base particle 11. That is, the graphene layer 12 may partially cover the surface of the base particle 11. On the contrary, the graphene layer 12 may wholly cover the surface of the base particle 11.

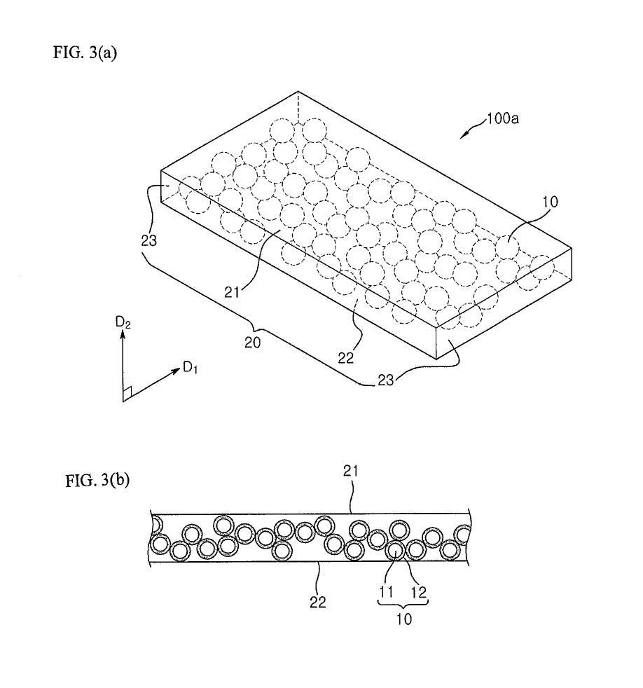

The graphene layer 12 may be synthesized by a chemical vapor deposition (CVD) method, and the like using a metal, which constitutes the base particle 11, as a catalyst. The graphene layer 12 may be synthesized in one to fifty layers according to the kind of metal which constitutes the base particle 11. The graphene layer 12 may have a thickness of several A to several hundred nm, and a thickness of several hundred nm to several μm, according to the time for synthesis. The thickness of the graphene layer 12 may be defined as an average value of the distances from the surface of the base particle 11 to the surface of the graphene layer 12. By the coated particle 10 including the graphene layer 12, heat transfer characteristics in a direction perpendicular to the in-plane direction of the sheet may be improved. The “in-plane direction” will be defined below while a sheet (100a, see FIG. 3) is described.

Hereinafter, a composition including the coated particle 10 and the base resin described above will be described. The composition may further include a solvent which dissolves the base resin, and a cross-linker. The overlapping specific description on the coated particle 10 will be omitted.

The base resin may be dissolved in the solvent. The composition may become a liquid state by dissolving the base resin in the solvent. That is, the coated particle 10 may be distributed in the base resin dissolved in the solvent. In a drying process of evaporating the solvent by adding heat to the composition, the base resin becomes a solid state. When the composition further includes a cross-linker, the cross-linker may be thermally reacted in the drying process to cross-link the base resin, thereby forming a cured product in a solid state.

Specific examples of the base resin include an ethylene resin, a propylene resin, a vinyl chloride resin, a styrene resin, a carbonate resin, an ester resin, a nylon resin or a silicone resin, and the like. These may be used either alone or in combination of two or more thereof. The base resin may have a weight average molecular weight of about 100,000 to about 500,000 in consideration of solubility with respect to the solvent.

The content of the coated particle 10 may be 5 parts by weight to 500 parts by weight with respect to 100 parts by weight of the base resin. For example, when the content of the coated particle 10 is less than 5 parts by weight, even though a sheet is manufactured by using the composition, the sheet may have little heat transfer characteristics. Furthermore, when the content of the coated particle 10 exceeds 500 parts by weight, it may be rather difficult for the coated particles 10 to be uniformly dispersed in the base resin.

Specific examples of the cross-linker include an isocyanate-based compound, an epoxy-based compound, a melamine-based compound or an organic peroxide, and the like. These may be used either alone or in combination of two or more thereof.

The content of the cross-linker may be 0 part by weight to 250 parts by weight with respect to 100 parts by weight of the base resin. When the content of the cross-linker is 0 part by weight, the composition does not include the cross-linker. For example, when the content of the cross-linker exceeds 250 parts by weight, even though the composition maximally contains the base resin, the cross-linker, which does not participate in the cross-linking reaction of the base resin, remains in the sheet which is a final product, thereby leading to deterioration in heat transfer characteristics of the sheet, or the base resin is excessively cured (over-cured), thereby leading to manufacturing a thermally modified sheet.

Specific examples of the solvent include ethyl acetate, methyl ethyl ketone, methylene chloride, tetrahydrofuran or chloroform, and the like. These may be used either alone or in combination of two or more thereof.

The solvent may dissolve the base resin and disperse the coated particle 10. In consideration of the solubility of the base resin and the dispersibility of the coated particle 10, the content of the solvent may be 30 parts by weight to 500 parts by weight with respect to 100 parts by weight of the base resin.

The composition may further include a carbon-containing powder. The composition may further include the carbon-containing powder, thereby improving heat transfer characteristics of a sheet manufactured by using the composition compared to heat transfer characteristics of a sheet including only the coated particle 10.

The carbon-containing powder is a structural body formed of a carbon-based material. The carbon-containing powder may include particles having various shapes, such as spherical particles, plate-like particles, and wire-like particles (or tubular particles). Specific examples of the carbon-containing powder include carbon nanotubes, graphene flake, graphite flake, oxidized graphene flake, expanded graphite flake, oxidized graphite flake, fullerene, carbon black or carbon fiber, and the like. These may be used either alone or in combination of two or more thereof.

For example, the carbon nanotubes are a tubular powder elongated in one direction, and the thermal conductivity of carbon nanotubes in the elongated direction thereof may be about 3,000 W/mK to about 3,500 W/mK.

The graphene flake is a plate-like structural body including graphene having a two-dimensional planar structure in which six carbon atoms are connected in a honeycomb-like hexagonal form. The thermal conductivity of graphene is about 5,300 W/mK.

In the present invention, the “graphene flake” is defined as a powder having a graphene laminated structure including one to fifty layers. The graphene flake includes at least one layer of graphene. That is, the graphene flake may have a single-layered structure composed of one-layered graphene, or a multi-layered structure including two or more layers of graphene. The graphene flake may have a specific surface area of about 50 m²/g to about 2,675 m²/g. The “specific surface area” means a surface area of graphene flake per unit mass.

Graphite flake also has a structure in which a plurality of graphenes is laminated, is a powder having a structure in which the number of graphenes laminated is larger than that in the graphene flake, and is defined as a powder which is differentiated from the graphene flake. The graphite flake has a specific surface area of a value larger than about 0 m²/g, and the value may be less than about 50 m²/g.

Oxidized graphene flake is a plate-like structural body including oxidized graphene. The oxidized graphene may be defined as a graphene in which a function group including an oxygen atom is bonded to the surface or edge thereof. The oxidized graphene flake includes oxidized graphene including at least one layer or more, and may further include graphene. In the oxidized graphene flake, the total number of layers of graphene and oxidized graphene may be fifty layers or less. That is, the oxidized graphene flake may be composed of oxidized graphene including 1 to 50 layers, or composed of graphene and oxidized graphene including at least one layer or more.

Further, the oxidized graphite flake includes oxidized graphene, and is a powder in which the total number of layers laminated is larger than that in the oxidized graphene flake. The oxidized graphite flake may be composed of oxidized graphene, or composed of oxidized graphene and graphene.

Expanded graphite flake is defined as a laminated structural body in which the distance between graphenes is larger than that in the graphite flake.

When the composition further includes the carbon-containing powder, the content of the carbon-containing powder may be 0 part by weight to 30 parts by weight with respect to 100 parts by weight of the base resin. When the content of the carbon-containing powder is 0 part by weight, the composition does not include a carbon-containing powder. For example, when the content of the carbon-containing powder exceeds 30 parts by weight, because it is difficult for the carbon-containing powder to be dispersed in the base resin, the content of the carbon-containing powder is preferably 30 parts by weight or less.

Hereinafter, sheets manufactured by using the coated powder 10 will be described.

FIG. 3 is a view illustrating a sheet according to an Example of the present invention. In FIG. 3, (a) is a three-dimensional view of the sheet, and (b) is a partially enlarged cross-sectional view of the sheet.

Referring to FIG. 3, a sheet 100a, which transfers heat, includes a base film 20 and a coated particle 10.

The base film 20 is a plate (for example, a plate having a rectangular shape) having a predetermined area and thickness and includes a first surface 21, a second surface 22, and side surfaces 23, the first surface 21 and the second surface 22 face each other, and the first surface 21 and the second surface 22 are connected to each other by the side surfaces 23.

The base film 20 includes a resin. The “resin” may be a base resin in a solid state. On the contrary, when the sheet 100a is manufactured by using a composition further including a cross-linker, the base film 20 may include a cured product which is a cross-linked base resin. Since the base resin is substantially the same as the base resin included in the composition, an overlapping specific description thereof will be omitted.

Specific examples of the base resin forming the base film 20 include an ethylene resin, a propylene resin, a vinyl chloride resin, a styrene resin, a carbonate resin, an ester resin, a nylon resin, a silicone resin or an imide resin, and the like. These may be used either alone or in combination of two or more thereof. The base film 20 may also include a cured product in which at least one resin exemplified above is cross-linked by a cross-linker.

The “in-plane direction” of the sheet 100a used below means an elongated direction D1 of a virtual line connecting any two points on any one surface of the first surface 21 and the second surface 22, which are a main surface of the sheet 100a. The “perpendicular direction” is defined as a direction perpendicular to the in-plane direction, that is, a direction D2 normal to the first surface 21 or the second surface 22.

Since the coated particle 10 has been previously described in detail, the overlapping description thereof will be omitted. The plurality of coated particles 10 are dispersed in the base film 20. In the plurality of coated particles 10 dispersed in the base film 20, the diameters thereof may be substantially the same as or different from each other.

In this case, at least a part of the coated particles 10 may be in contact with each other in an in-plane direction and/or in a direction perpendicular thereto in the base film 20. By the coated particles 10 which are in contact with each other, the sheet 100a may have heat transfer characteristics in the in-plane direction and in the perpendicular direction.

Meanwhile, the content of the coated particle 10 in the sheet 100a may be 5 parts by weight to 500 parts by weight, with respect to 100 parts by weight of the base resin included in the base film 20. When the content of the coated particle 10 is less than 5 parts by weight with respect to 100 parts by weight of the base film 20, the coated particles 10 are minimally contacted with each other, so that heat transfer characteristics of the sheet 100a are not exhibited. Furthermore, when the content of the coated particle 10 exceeds 500 parts by weight, it may be rather difficult for the coated particles 10 to be uniformly dispersed in the base film 20.

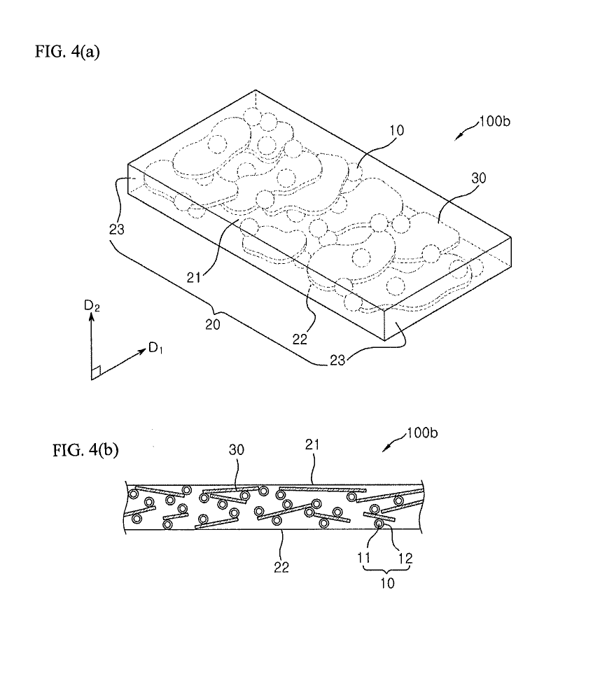

FIG. 4 is a view illustrating a sheet according to another Example of the present invention. In FIG. 4, (a) is a three-dimensional view of a sheet 100b, and (b) is a partially enlarged cross-sectional view of the sheet 100b.

Referring to FIG. 4, the sheet 100b includes a base film 20, a coated particle 10, and a carbon-containing powder 30. Since the sheet 100b is substantially the same as the sheet 100a described in FIG. 3 except for further including the carbon-containing powder 30, the overlapping specific description thereof will be omitted.

The carbon-containing powder 30 is a structural body formed of a carbon-based material. Since the carbon-containing powder 30 is substantially the same as the carbon-containing powder included in the composition according to the present invention, the overlapping specific description thereof will be omitted.

As an example, since graphene has a 2-dimensional plate-like structure, the heat transfer route in the graphene is substantially the same as the in-plane direction thereof. Heat is transferred even in a direction perpendicular to the in-plane direction of graphene, but the heat transfer is very minimal as compared to the degree that heat is transferred in the in-plane direction of graphene, so that the heat transfer route of graphene may be substantially the same as the in-plane direction thereof. In this case, the in-plane direction of graphene may be substantially the same as the in-plane direction of the sheet 100b, or may be inclined at a predetermined angle θ₁. The predetermine angle θ₁ may be about −60° to +60° based on the first surface 21 or the second surface 22. That is, the interplanar angle between the basal plane of graphene and the first surface 21 or the second surface 22 may be about −60° to +60°.

The coated particle 10 may be brought into contact with the carbon-containing powder 30, thereby improving heat transfer characteristics in the perpendicular direction. At least a part of the coated particle 10 may be interposed between the carbon-containing powders 30, so that the carbon-containing powders 30 may be indirectly connected to each other through the coated particle 10. In this case, the heat transfer route in the perpendicular direction may be substantially the same as the normal direction D2, or may be the same as a direction inclined at a predetermined angle θ₂. The predetermined angle θ₂ may be −30° to +30° based on the normal direction D2.

The content of the carbon-containing powder 30 in the sheet 100b may be 30 parts by weight or less with respect to 100 parts by weight of the base resin included in the sheet 100b. For example, when the content of the carbon-containing powder 30 exceeds 30 parts by weight, it may be difficult for the carbon-containing powder 30 to be uniformly dispersed in the sheet 100b.

The carbon-containing powder 10 may be brought into contact with the coated particle 10, thereby improving heat transfer characteristics of the sheet 100b in an in-plane direction thereof as well as in a direction perpendicular thereto. That is, at least a part of the carbon-containing powder 30 may be interposed between the coated particles 10, so that the carbon-containing powders 30 may be indirectly connected to each other through the coated particle 10.

Meanwhile, the content of the coated particle 10 in the sheet 100b may be 5 parts by weight to 500 parts by weight, with respect to 100 parts by weight of the base resin included in the sheet 100b.

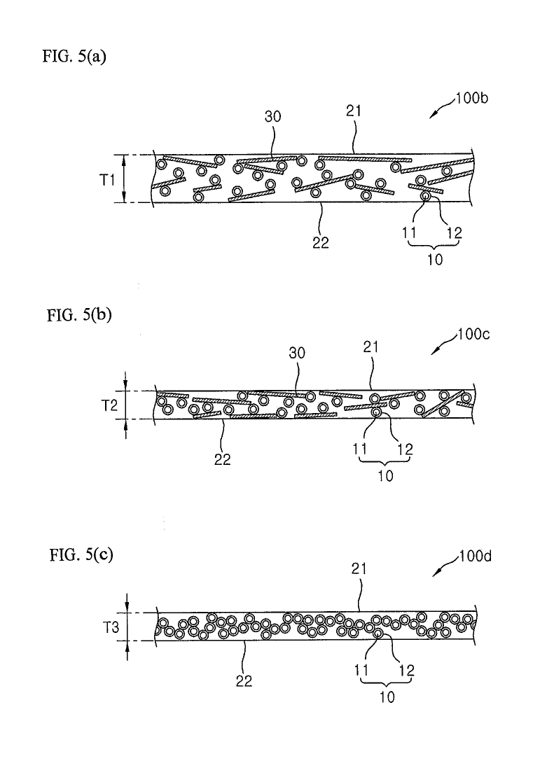

FIG. 5 is a view illustrating a sheet according to a modified Example of the present invention. In FIG. 5, (a) is a partially cross-sectional view of a sheet manufactured without compression, and (b) is a partially cross-sectional view of a compressed sheet.

The sheet 100b illustrated in FIG. 5(a) is substantially the same as the sheet 100b described in FIG. 4. Further, a sheet 100c illustrated in FIG. 5(b) is substantially the same as the sheet 100b described in FIG. 4, except for the arrangement of the coated particle 10 and the carbon-containing powder 30. Therefore, the overlapping detailed description thereof will be omitted.

Referring to FIG. 5(b), the compressed sheet 100c includes a base film 20, a coated particle 10, and a carbon-containing powder 30. The sheet 100c has a second thickness T2 smaller than a first thickness T1 of the sheet 100b manufactured without compression.

When the sheets 100b and 100c having the first surfaces 21 of which the areas are the same as each other are compared with each other, the distance between the coated particle 10 and the carbon-containing powder 30 in the sheet 100c having the second thickness T2 is relatively closer than the distance between the coated particle 10 and the carbon-containing powder 30 in the sheet 100b having the first thickness T1. In addition, the distance between the coated particles 10 or the distance between the carbon-containing powders 30 in the sheet 100b illustrated in FIG. 5(b) is closer than that in the sheet 100b illustrated in FIG. 5(a). Accordingly, heat conductivity of the compressed sheet 100c may be improved as compared to thermal conductivity of the sheet 100b manufactured without compression.

Meanwhile, it is possible to manufacture a compressed sheet 100d having a third thickness T3 smaller than the second thickness T2 of the sheet 100c illustrated in FIG. 5(b) by compressing the sheet 100a including only the coated particle 10, which is illustrated in FIG. 3. That is, the thickness of the compressed sheets 100c and 100d may vary according to the constituent element included in the base film 20. The sheet 100d illustrated in FIG. 5(c) may have improved heat conductivity compared to that of the sheet 100a illustrated in FIG. 3.

That is, considering that as the distance between the coated particles 10, the distance between the carbon-containing powders 30, or the distance between the coated particle 10 and the carbon-containing powder 30 becomes closer, heat may be easily transferred, conductivity of the sheets 100c and 100d may be further improved when the sheets 100c and 100d are manufactured by performing the compression process.

According to the description in FIGS. 2 to 5, the sheets 100a and 100d including the coated particles 10 or the sheets 100b and 100c further including the carbon-containing powders 30 may have improved heat transfer characteristics compared to a heat radiation sheet including only the carbon-containing powders 30. In particular, heat transfer characteristics in the “perpendicular direction” described above may be improved. In this case, the sheets 100a, 100b, 100c, and 100d according to the Examples of the present invention may have a heat conductivity of about 200 W/mK to about 500 W/mK in an in-plane direction thereof, and a heat conductivity of about 3 W/mK to about 50 W/mK in a direction perpendicular to the in-plane direction.

In addition, since the sheets 100a and 100d including the coated particles 10 or the sheets 100b and 100c further including the carbon-containing powders 30 are lighter than a metal radiation sheet having the same size, it is possible to reduce the weights of various electronic devices or electronic equipment using the sheets 100a, 100b, 100c, and 100d according to the present invention.

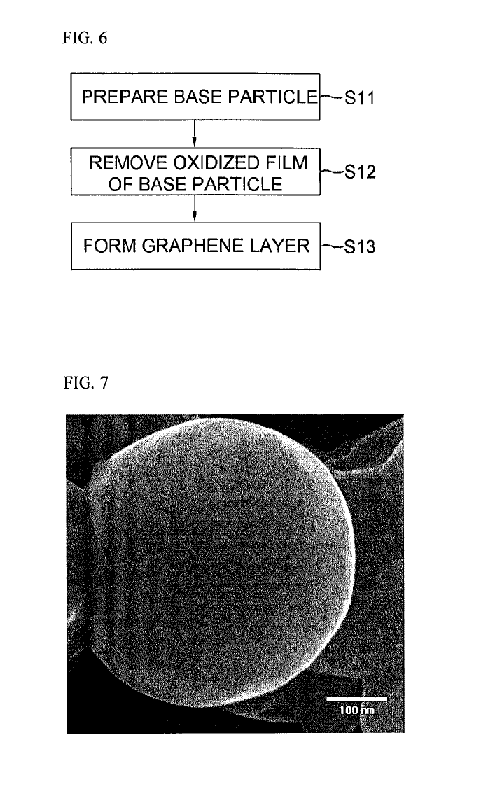

Hereinafter, a method for preparing the coated particle according to the present invention will be described with reference to FIGS. 6 to 8, and a method for manufacturing a sheet by using a composition for manufacturing a sheet according to the present invention will be described with reference to FIG. 9.

FIG. 6 is a view for describing a method for manufacturing a coated particle according to exemplary embodiments of the present invention.

Referring to FIG. 6, a base particle is first prepared in order to prepare a coated particle (Step S11). Since the description on the base particle is substantially the same as that in FIG. 1, the specific description thereof will be omitted.

An oxidized film formed on the surface of the base particle is removed (Step S12).

While the base particle is stored while being exposed to air, an oxidized film may be formed on the surface thereof. In order to stably form a graphene layer on the surface of the base particle, a process of removing the oxidized film is performed before the graphene layer is formed. For example, after the base particle is loaded into a chamber, the oxidized film may be reduced by increasing the temperature of the chamber, and supplying a hydrogen gas into the chamber. It can be seen that due to the reduction of the oxidized film, the oxidized film formed on the surface of the base particle has been substantially removed. The process for removing the oxidized film may be omitted in some cases.

A graphene layer is formed on the surface of the base particle (Step S13).

For example, a carbon supply source such as methane or acetylene is provided in a gas state into the chamber maintained at high temperature. In this case, a hydrogen gas may also flow into the chamber. In order to form a graphene layer, the temperature of the chamber may be maintained at about 1,000° C. After a predetermined time has passed, the graphene layer may be formed on the surface of the base particle by decreasing the temperature of the chamber to room temperature while flowing an inert gas into the chamber. Accordingly, the coated particle according to the Example of the present invention may be prepared.

It is possible to adjust the thickness of the graphene layer and the number of layers of graphene, which constitutes the graphene layer, according to the kind of metal which forms the base particle, the amount of a methane gas and a hydrogen gas flowing, the time for the process, and the like. As an example, when the base particle is formed of copper, the graphene layer may have a structure in which 1 to 3 layers of graphene are laminated. On the contrary, when the base particle is formed of nickel, the graphene layer may have a structure in which 1 to 50 layers of graphene are laminated.

FIG. 6 describes a thermal chemical vapor deposition (TCVD) method as a method for forming the graphene layer, but the graphene layer may be formed by using various methods such as a plasma enhanced chemical vapor deposition (PECVD) method and a microwave plasma enhanced chemical vapor deposition (MPECVD) method in addition to the thermal chemical vapor deposition method.

### Preparation of Coated Particle

A base particle formed of nickel was prepared, and the base particle was disposed in a chamber. The temperature of the chamber was increased to about 1,000° C. while a hydrogen gas was flowed at a flow rate of about 10 sccm for about 30 minutes, thereby removing an oxidized film on the surface of the base particle. Subsequently, a methane gas (CH₄) and a hydrogen gas (H₂) were provided into the chamber at a flow rate of about 10 sccm for about 60 minutes while the temperature of the chamber was maintained at about 1,000° C. Next, while an argon (Ar) gas was flown into the chamber at a flow rate of about 100 sccm, the chamber was cooled at a rate of about 60° C./min, thereby preparing a coated particle having a diameter of about 500 nm to about 600 nm.

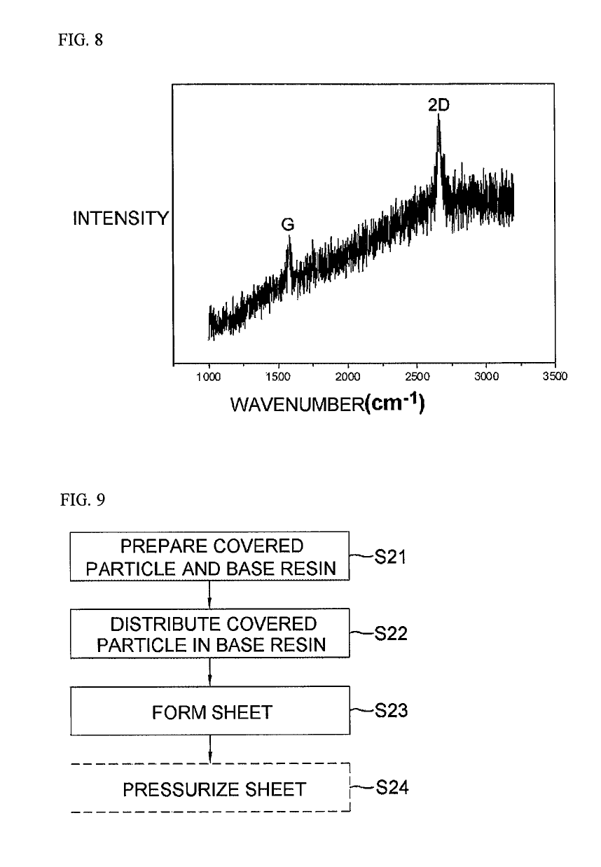

The coated particle prepared was photographed by a scanning electron microscope (SEM) and is illustrated in FIG. 7, and the result of measurement by using a Raman spectroscope is illustrated in FIG. 8.

FIG. 7 is a scanning electron microscope photograph of a coated particle according to an Example of the present invention, and FIG. 8 is a graph of the result of measuring a coated particle manufactured according to an Example of the present invention by using the Raman spectroscopy.

Referring to FIG. 7, it can be seen that a coated particle having a diameter of about 500 nm to about 600 nm has been prepared through the process described above. The coated particle prepared has a substantially spherical shape.

In FIG. 8, an x-axis indicates a wavenumber (unit: cm⁻¹). The “wavenumber” means a value obtained by dividing a difference between a frequency (unit: sec⁻¹) of light irradiated on a subject material and a frequency of light scattered by the subject material by the speed of light (unit: cm/sec). When light is irradiated on the subject material, the frequency of light scattered by the subject material may vary according to the molecule's inherent vibration, rotation energy and/or lattice vibration energy of the subject material, which refers to the “Raman scattering”. A y-axis indicates the intensity of the scattered light, and means that the larger the value of the y-axis is, the subject material has the greater number of structures or bonds which absorb light having a frequency calculated from the wavenumber.

Referring to FIG. 8, it can be seen that peaks having a strong intensity appear at about 1,580 cm⁻¹ and about 2,700 cm⁻¹.

In general, a peak appearing near about 1,580 cm⁻¹ refers to a “G-peak”, and it can be seen from the presence of the G-peak that an sp² bond between carbon and carbon is present. In addition, a “2D-peak” is a peak appearing near about 2,700 cm⁻¹, and a peak due to the double resonance phenomenon in a hexagonal lattice structure.

According to the above description, it can be seen from the appearance of the G-peak in the graph of FIG. 8 that an sp² bond of carbon and carbon is present, and from the appearance of the 2D-peak in the graph of FIG. 8 that the coated particle includes graphene. That is, it can be seen that a coated particle including a graphene layer is prepared through the process described above.

### Manufacture of Sheet

The coated particle prepared above, an epoxy-based compound EJ-1030 (trade name, JSI Co., Ltd., Korea) as a cross-linker, and a WNGP-50 graphene powder (trade name, BMS Tech, Korea) as a graphene flake were dispersed in a solution in which KE-1606 (trade name, Shin-Etsu Chemical Co., Ltd., Japan) as a silicone resin was dissolved in chloroform, thereby preparing a composition for manufacturing a sheet. With respect to the total weight of the composition, the content of chloroform was about 16.4 wt %, the content of the silicone resin was about 32.6 wt %, the content of the epoxy-based compound was about 1 wt %, the content of the graphene flake was 8 wt %, and the content of the coated particle was about 42 wt %.

A sheet having a thickness of about 500 μm was manufactured by using the composition, and the heat conductivity of the sheet in an in-plane direction thereof and the heat conductivity of the sheet in a direction perpendicular to the in-plane direction were measured by LFA-457 (trade name, NETZSCH, Inc.).

As a result, it was found that the heat conductivity in the in-plane direction was about 400 W/mK, and the heat conductivity in the direction perpendicular to the in-plane direction was about 10 W/mK.

According to the experiment and the experimental result, when compared to the fact that heat conductivity of the graphite heat radiation sheet in an in-plane direction thereof was approximately 130 W/mK and the heat conductivity in a direction perpendicular to the in-plane direction was at a level of almost 3 W/mK, it can be seen that the heat conductivities of a sheet manufactured by using the composition including the coated particle according to the present invention were high in an in-plane direction thereof and in a direction perpendicular to the in-plane direction.

Hereinafter, a composition for manufacturing a sheet including the coated particle prepared in FIG. 6, and a method for manufacturing a sheet by using the composition will be described with reference to FIG. 9.

FIG. 9 is a view for describing a method for manufacturing a sheet according to the Examples of the present invention.

Referring to FIG. 9, a base resin and a coated particle are prepared in order to prepare a composition for manufacturing a sheet (Step S21).

The coated particle may be prepared through the process which is substantially the same as that described in FIG. 6.

The base resin may be prepared by being dissolved in a solvent. The base resin itself is in a solid state, but may be a solution in a liquid state by being dissolved in the solvent. Specific examples of the base resin include an ethylene resin, a propylene resin, a vinyl chloride resin, a styrene resin, a carbonate resin, an ester resin, a nylon resin, a silicone resin or an imide resin, and the like. These may be used either alone or in combination of two or more thereof.

The coated particle is dispersed in a base resin dissolved in the solvent (Step S22).

The coated particle may be dispersed in the base resin by using a vortex mixer. On the contrary, the coated particle may be dispersed in the base resin by various methods such as a mechanical stirrer, a homogenizer, sonication, and milling.

Accordingly, a composition for manufacturing a sheet including the coated particle and the base resin may be prepared. In this case, the composition may further include a carbon-containing powder. The carbon-containing powder may be easily dispersed together with the coated particle in the base resin in the step of dispersing the coated particle in the base resin. When the composition for manufacturing a sheet includes the carbon-containing powder, the content of the carbon-containing powder may be 30 parts by weight or less with respect to 100 parts by weight of the base resin.

A sheet is formed by using the composition prepared as described above (Step S23).

The sheet may be manufactured by coating the composition on a base substrate. For example, the sheet may be formed by casting the composition on the base substrate, and then removing the solvent. Specifically, it is possible to use a polydimethylsiloxane film (PDMS film), a polyethylene terephthalate film (PET film), a polyimide film (PI film), a polyurethane film, a glass substrate, a steel belt or a steel drum, and the like as the base substrate, and the solvent is removed by coating the composition on the base substrate, and drying the composition. Accordingly, the base resin, the coated particle, and the carbon-containing powder remain on the base substrate, thereby forming a film having a predetermined thickness. The sheet may be formed by separating the film from the base substrate. On the contrary, a sheet according to an Example of the present invention may be manufactured by extruding the composition.

During the process of manufacturing the sheet, a pressurization process may be additionally performed before the base resin is cured (Step S24).

In the pressurization process, the thickness of the sheet may be adjusted, such that the coated particles, or the coated particle and the carbon-containing powder are brought into contact with each other in the finally manufactured sheet. In the pressurization process, pressure is applied in order to manufacture the sheet, and heat may be additionally added.

As described above, the detailed description of the present invention has described specific examples, but various modifications can be made in a range without departing from the scope of the present invention. Therefore, the scope of the present invention should not be limited to the described Examples, and should be defined by not only the claims to be described below, but also those equivalent to the claims.

1. A coated particle comprising:
a base particle composed of a metal; and
a graphene layer which covers at least a part of a surface of the base particle.

2. The coated particle of claim 1, wherein the graphene layer comprises at least one layer or more of graphene.

3. The coated particle of claim 1, wherein the base particle comprises at least one of nickel (Ni), copper (Cu), iron (Fe), ruthenium (Ru), cobalt (Co), platinum (Pt), and iridium (Ir).

4. The coated particle of claim 1, wherein the base particle has a spherical shape, a plate shape, or a wire shape.

5. The coated particle of claim 4, wherein the base particle is a spherical particle having a diameter of 5 nm to 10 μm.

6. The coated particle of claim 4, wherein the base particle is a wire-like particle having a length of 50 nm to 10 μm.

7. A composition comprising:
a base resin; and
a coated particle which is distributed in the base resin, and comprises a base particle and a graphene layer which covers at least a part of a surface of the base particle.

8. The composition of claim 7, wherein the base particle comprises at least one of nickel (Ni), copper (Cu), iron (Fe), ruthenium (Ru), cobalt (Co), platinum (Pt), and iridium (Ir).

9. The composition of claim 7, wherein the base particle is a spherical particle having a diameter of 5 nm to 10 μm.

10. The composition of claim 7, wherein the graphene layer comprises at least one layer of graphene.

11. The composition of claim 7, wherein a content of the coated particle is 5 to 500 parts by weight with respect to 100 parts by weight of the base resin.

12. The composition of claim 7, further comprising:
a carbon-containing powder distributed in the base resin together with the coated particle.

13. The composition of claim 12, wherein the carbon-containing powder comprises at least one of carbon nanotubes, graphene flake, oxidized graphene flake, graphite flake, oxidized graphite flake, expanded graphite flake, fullerene, carbon fiber, and carbon black.

14. The composition of claim 12, wherein a content of the carbon-containing powder is 30 parts by weight or less with respect to 100 parts by weight of the base resin.

15. The composition of claim 7, wherein the base resin comprises at least one of an ethylene resin, a propylene resin, a vinyl chloride resin, a styrene resin, a carbonate resin, an ester resin, a nylon resin, a silicone resin, and an imide resin.

16. A sheet transferring heat, comprising:
a base film comprising a base resin; and
a coated particle which is distributed in the base film, and comprises a base particle and a graphene layer which covers at least a part of a surface of the base particle.

17. The sheet of claim 16, wherein the coated particle is in contact with at least one of the other coated particles.

18. The sheet of claim 16, wherein a content of the coated particle is 5 to 500 parts by weight with respect to 100 parts by weight of the base resin.

19. The sheet of claim 16, wherein the base particle comprises at least one of nickel (Ni), copper (Cu), iron (Fe), ruthenium (Ru), cobalt (Co), platinum (Pt), and iridium (Ir).

20. The sheet of claim 16, wherein the base particle is a spherical particle having a diameter of 5 nm to 10 μm.

21. The sheet of claim 16, wherein the graphene layer comprises at least one layer of graphene.

22. The sheet of claim 16, further comprising:
a carbon-containing powder distributed in the base film.

23. The sheet of claim 22, wherein the sheet comprises the coated particle and the carbon-containing powder which are brought into contact with each other.

24. The sheet of claim 22, wherein the carbon-containing powder comprises at least one of carbon nanotubes, graphene flake, oxidized graphene flake, graphite flake, oxidized graphite flake, expanded graphite flake, fullerene, carbon fiber, and carbon black.

25. The sheet of claim 22, wherein a content of the carbon-containing powder is 30 parts by weight or less with respect to 100 parts by weight of the base resin.

26. The sheet of claim 16, wherein the base resin comprises at least one of an ethylene resin, a propylene resin, a vinyl chloride resin, a styrene resin, a carbonate resin, an ester resin, a nylon resin, a silicone resin, and an imide resin.
